(19) United States
(12) Patent Application Publication
(10) Pub. No.: US 2013/0149682 A1
(43) Pub. Date: Jun. 13, 2013

(54) METHODS AND SYSTEMS FOR SIMULATION BASED MEDICAL EDUCATION

(71) Applicant: Medicolegal Consultants International, LLC, Denver, CO (US)

(72) Inventor: Stephen S. Raab, Denver, CO (US)

(73) Assignee: MEDICOLEGAL CONSULTANTS INTERNATIONAL, LLC, Denver, CO (US)

(21) Appl. No.: 13/708,379

(22) Filed: Dec. 7, 2012

Related U.S. Application Data
(60) Provisional application No. 61/568,776, filed on Dec. 9, 2011.

(51) Int. Cl. G09B 19/00

(52) U.S. Cl. CPC G09B 19/00
USPC 434/219; 434/353

(57) ABSTRACT

Provided herein are methods and systems for training and/or assessing competency of an individual who is a medical student or medical professional. The methods comprise the steps of: (a) providing a first module of one or more graded slides; (b) testing an individual's knowledge of the slides; (c) scoring the individual's knowledge; and (d) comparing the score to a baseline score or a standard score. A score above the baseline score or standard score indicates the individual's competency. The steps can further comprise providing feedback regarding the individual's knowledge of the slides.

### RELATED APPLICATIONS

This application claims priority under 35 U.S.C. 119 (e) to U.S. Provisional Patent Application Ser. No. 61/568,776, entitled “Simulation Based Medical Education”, filed Dec. 9, 2011, the disclosure of which is hereby incorporated by reference in its entirety.

### TECHNICAL FIELD

The present disclosure is in the field of education, and, in particular, in the field of medical education.

### BACKGROUND

The IOM definition of an error is the failure of a planned action to be completed as intended or the use of a wrong plan to achieve an aim. Medical errors permeate all levels of patient care.

With regard to anatomic pathology safety, diagnostic error frequency shows passive detection methods: <1% to 5% of surgical pathology cases; and active detection methods: 1% to 40% of cases.

Zarbo and D'Angelo show that 33% of anatomic pathology specimens are associated with diagnostic defects.

Grzybicki et al. mention that 70% of anatomic pathology specimens are associated with identification defects, i.e. observational errors.

Reasons errors include: variability in the diagnostic work-up and management, variability in tissue procurement techniques, and variability in laboratory processes (tissue examination, processing, interpretation, and reporting), and educational processes.

The current state of assessment of competence includes testing and the American Board of Pathology is adopting a new model based on the core competencies (one weakness is that no testing of actual practice or evaluation of individual strengths and flaws).

Accreditation Council for Graduate Medical Education (ACGME) includes six core competencies. They are patient care, medical knowledge, practice-based learning and improvement, communication skills, professionalism, and system-based practice.

Current State of Education: Accreditation Council for Graduate Medical Education (ACGME) shows that most residents spend two years on Anatomic Pathology rotations. They learn using an apprenticeship model. There is subspecialty teaching in some programs.

Weaknesses in the current training include: training on real patent specimens (increasing risk to patients), lack of deliberate practice, variable feedback, variable practice conditions (different daily volumes and complexities), immersion in system problems (e.g., inefficiencies), variable pathologist educational skill sets, lack of pathologist time, and lack of performance in real life settings.

The present invention is directed toward overcoming one or more of the problems discussed above.

### SUMMARY OF THE EMBODIMENTS

Provided herein are various methods and systems for simulation based medical education.

In some embodiments the methods of assessing competency comprise providing a first module of one or more graded slides; testing an individual's knowledge of the slides; scoring the individual's knowledge; and comparing the score to a baseline score or a standard score. A score above the baseline score or standard score indicates the individual's competency.

In some embodiments the methods of training comprise providing a first module of one or more graded slides; testing an individual's knowledge of the slides; scoring the individual's knowledge; comparing the score to a baseline score or a standard score; and providing feedback regarding the individual's knowledge of the slides.

In some embodiments the methods of training further comprise the step of providing a second module of one or more graded slides, the second module being chosen based on the comparison of the individual's score to the baseline score or standard score.

In some embodiments a system for assessing competency comprises a first module of one or more graded slides; a baseline score or a standard score; and a verbal or electronic means of comparing the individual's score to the baseline or standard score.

In some embodiments a system for training comprises a first module of one or more graded slides; a baseline score or a standard score; and a feedback mechanism.

In some embodiments, the methods are computer-implemented. The computer-implemented embodiments include a software component for completing a training module for a practitioner, a computer-readable storage medium including initial evaluation graded slides, and one or more set of education or training graded slides.

Other embodiments and aspects are contemplated herein and will be apparent from the description below.

### DETAILED DESCRIPTION

Disclosed herein are methods and educational systems that assesses pathologist competency, provides simulation-based medical education for improvement, and provides continuous assessment of competency. This system may be integrated into current assessments of competency (testing boards), licensure, granting of hospital privileges, medical education, safety assessment (medical error assessment programs), and pathology training (fellowship and residency).

Simulation-based medical education (SBME) is an educational/training method that allows computer-based and/or hands-on practice and evaluation of clinical, behavioral, or cognitive skill performance without exposing patients to the associated risks of clinical interactions.

Simulation methods and systems provide for feedback, deliberate practice, curriculum integration, outcome measure, fidelity, skills acquisition and maintenance, mastery learning, transfer to practice, team training and high-end stakes testing.

The simulation-based educational system can assess and improve one or more areas of pathology work (gross tissue examination, communication, diagnostic interpretation, ancillary test use, and report generation). An illustrative embodiment is the diagnostic interpretation of pathology slides, but it will be understood that the methods and systems provided herein are applicable to a variety of medical work and pathology work. Pathology practice includes: accessioning and gross examination, histotechnology, diagnostic interpretation, intraoperative consultation, communication, report generation and quality improvement. The systems and methods provided herein are useful in testing and/or training each of these tasks. As referred to herein, a diagnosis is an interpretation or classification of a patient's disease. A pathology diagnosis is the interpretation based on the findings seen, for example, on the slides or images.

In one embodiment, the system is a specific simulation module. The system can first assess diagnostic interpretation competency by providing slides representing a “typical” practice. These slides can be chosen from a bank of slides (or digital images) that represent all diseases in their various manifestations (e.g., typical and atypical disease patterns) with various “noise” levels (e.g., artifacts that limit interpretation).

In one aspect, one or more of the slides from the bank of slides is classified by internationally recognized experts in terms of difficulty (based on assessment of the case's representativeness of the classic pattern and noise level). In another aspect, all of the slides from the bank of slides are classified by experts.

In some embodiments, in the first competency assessment, individual performance can be assessed by comparison with a large number of other pathologists of many skill sets (ranging from master to novice). In some aspects, assessment can also determine strengths and weaknesses of individual cognitive assessment of specific diseases, mimics, and noise recognition. Thus, embodiments herein are able to set an individual in a specific category of competence and recognize the components that could be targeted for improvement.

In some embodiments, the educational improvement component can involve classic aspects of simulation, such as feedback, fidelity, continuous assessment, and self-directed learning. The learner is provided with modules based on his/her current competence and focused on specific areas of improvement, reflecting the trainee's specific weaknesses. The trainee will complete a checklist for each case reflecting their knowledge of specific criteria (observed on the slide and representing the characteristics of the disease) and potential noise.

In some embodiments, the feedback is direct and through an expert pathologist (task trainer). In some embodiments, the feedback is virtual-electronic. In some aspects, the feedback can be delivered through the internet, whether by the trainer or by a virtual trainer. For more experienced trainees, feedback can include one or more of the following: self assessment of biases and other failures in thinking; the use of specific checklists of criteria; the use of heuristic checklists of disease processes; and the use of checklists of biases. In some embodiments, the feedback is verbal and can include any one or more of the following: socratic, question criteria, question heuristics, and question bias.

Illustratively, the task trainer goes over each case with the learner and assesses final competence (was the case correctly diagnosed?), correct classification of criteria, noise level, and cognitive biases. Each module can contain a proportion of cases reflecting weaknesses and more challenging cases in order to improve over all skill sets. Feedback can be in the form of questions designed to engage the learner to identify the components that lead to error (did they recognize the criteria, biases, noise, etc.).

In some embodiments, the module steps include: examine current level of competence; determine levels of weakness; and choose cases based on level of competence and weakness.

The systems provided herein can include modules. Modules can be daily, weekly, or monthly exercises. For example, a module can include 20 cases per day, with variable difficulty and case complexity, and can optionally include a requirement to produce a diagnosis and a report, requirement to order ancillary tests, feedback, deliberate practice and scale difficulty of case presentation to performance.

In some embodiments, the module consists of 20 cases (shown on slides, for example). The cases can be graded, for example, on a 1-5 or 1-10 scale, for example, with 5 or 10, respectively, requiring master-level recognition and 1 requiring master-level novice. It will be understood that any scale is contemplated herein, however. For example, the slide difficulty scale can be 1-3, 1-4, 1-5, 1-10, 1-20, etc.

One or more of the following factors can be considered when assessing the difficulty of a slide:
a. Initial assessment of difficulty based on fast thinking (pattern recognition);
b. Diseases may be described by general histologic/cytologic/ancillary testing criteria;
c. “Easy” cases represent classic cases of criteria;
d. All diseases have a set of criteria that overlap with other diseases;
e. More difficult cases of a disease may have criteria that overlap more with other diseases; and
f. More difficulty cases may reflect noise in the system (e.g., poor sample or poor environment).

Illustratively, a learner is scored at competency level 6 (on a 1-10 scale), indicating that she is overall average in competence but she scored at level 3, 3, and 3 in specific areas—reflecting lower levels of competence. Her module will contain 3 examples of each of these areas in which she performed at a lower level (the slides will be at levels 4 or 5) and in the other areas, she will received cases at a competency level of 7 or 8). The Learner then takes the module, her performance is scored and feedback provided, and the next module can be chosen.

In some aspects, the learner takes sequential modules that become more challenging reflecting his/her developing skill sets. Information on each case can be stored in a database and used to measure the validity of previously assessed cases. This can be repeated for 1, 5, 10 or more modules.

It is contemplated herein that the systems and methods are useful in several ways, including but not limited to the following: First, the systems and methods can be used for pathology trainees in conjunction with traditional apprenticeship educational methods. Second, the competency assessment can be used to track trainee learning and/or to measure pathologist competence in specific pathology subspecialties. This component can be used by hospitals, pathology boards, and pathology practices that want to know general levels of competence and weakness of all their pathologists. Last, the educational component can be used as continuous medical education piece to improve the practice of all pathologists.

One embodiment herein provides a method for training a medical health professional/physician in pathology using simulation-based medical education training which is optionally combined with hands-on interactive practice.

Methods and systems provided herein can be simple or sophisticated. More sophisticated embodiments include methods and systems developed for a particular practice or specialty. Steps can include any one or more of the following: standardization of practice, establishment of resident milestones by post-graduate year, testing for baseline, development of simulation modules, and testing.

In some embodiments, the systems and methods train and/or assess competency in diagnosis. In some aspects, the systems and methods include training or assessment of diagnostic interpretation, ancillary test use, and reporting.

Learning models show that fast thinking is learning and recognizing criteria of disease, while slow thinking is logical and rational, taking place initially when recognizing criteria, and again in situations when a “pattern” doesn't fit. Errors typically arise by a failure of pattern recognition and failure in slow thinking (e.g., attributed to lack of memory, personal biases, and/or personal experience).

In some embodiments, the methods and systems comprise a slide bank (virtual and/or real), where the slides are graded by difficulty. In some aspects, the testing is performed using a select slide set (based on difficulty) to assess baseline; in some aspects, reproduction of work using material from slide bank (i.e., targeted to subspecialty) can be used to assess competency or fulfill continuing education requirements.

Performance can be evaluated on ability to score equal to peers or some other equivalent standard. Learning can occur by providing cases of greater difficulty with feedback. In some aspects, the education systems and methods comprise assessment and teaching of criteria to build “patterns” of disease.

In some aspects, secondary education systems and methods comprise assessment of overlap of disease criteria and “finer-tuned” criteria. In some aspects, tertiary education comprises heuristics.

Embodiments of the invention include computer-implemented methods for simulation based medical education. Embodiments are generally understood to operate in a stand-alone computing environment although one of skill in the art would understand that a variety of other computer-based environments are within the scope of embodiments of the invention (for example, computer program operations can occur remotely in a client/server manner). As one of skill in the art would readily understand, embodiments herein can include a computing device with processing unit, program modules, such as an operating system, software modules and computer-readable media.

In one embodiment, the methods are described implemented in a computing environment. In another embodiment, the methods are described implemented in a non-computing environment. In yet another embodiment, some aspects of the methods described herein are implemented in a computing environment while other aspects are not. The following flowchart provides detail on how these steps could be managed in any of the three environments described above by one of skill in the art (note that the sequence of steps below is illustrative and can be modified in relation to each other):

1. Identify content expert

2. Expert defines list of subspecialty diseases to be studied

3. Expert develops criterion/pattern checklist(s)
a. Expert develops list of cellular features important in disease separation
b. Expert develops list of architectural features important in disease separation

4. Specific individual cases of all diseases in that subspecialty identified from institutional database and pathology reports and slides located

5. Expert completes a checklist for “classic” examples of each disease
a. The checklist will display the classic cellular features of disease
b. The checklist will display the classic architectural features of disease
c. The combination of these criteria will be the classic pattern of disease

6. Expert will systematically populate the case bank with cases of each disease
a. All diseases will be graded by rarity (1-5 Likert scale)
b. For disease 1, expert will review each case and
   i. Complete the criteria checklist
      1. Grade the case by representativeness (1-5 Likert scale) (note that a classic disease will “match” the classic case on the criteria checklist and will have a score of 5 in representativeness)
   ii. Complete the quality checklist (note the quality checklist has been previously developed and is not developed uniquely for each case)
      1. Grade the case by quality criteria (1-5 Likert scale)
   iii. Complete the bias checklist (note the bias checklist has been previously developed and is not developed uniquely for each case)
      1. Choose the biases most likely to occur on the basis of disease rarity, representativeness, and quality
   iv. Case information and associated expert checklist data entered into database
   v. Complete the additional material and study checklist
   vi. Iteratively accumulate additional cases of each disease
      1. Ideally will collect at least 25 cases of each combined representativeness and quality score (25 score 5+5, 25 score 4+5, etc., for a total of at least 1050 cases per disease) (note this will not be possible for all diseases because of disease rarity and because we will want more cases for specific features that cause error)

7. Construct initial evaluation module by choosing cases from case bank
a. Choose 25 cases of variable difficulties with representation from each of the more common disease categories and several from the rare diseases
b. Average score for all cases will be 3.0
c. Additional evaluation modules will be constructed based trainee score, strength and weakness

8. Provide evaluation module to trainee
a. Trainee tacks module
b. Enter diagnoses into database
c. Trainee completes quality, representativeness, bias, and additional material and study checklists on all cases incorrectly answered and on the same number of correctly answered cases
d. Checklist data entered into database
e. Score performance
   i. Determine overall score
   ii. Determine strength areas (>4 scores) in diagnosis subtypes
   iii. Determine weakness areas (>3 scores) in diagnosis subtypes
   iv. Determine quality artifact weaknesses
   v. Determine bias weaknesses
f. Provide scores to trainees

9. Develop education module #1 for trainee (modules will be trainee specific)
a. Build module with 10 cases depending on overall score of trainee and strengths and weaknesses (for example, if trainee scored a 2.7, additional cases with an average score of 2.8-3.0 will be provided with more difficult cases chosen from weaker areas of representativeness, quality, and bias)
b. Cases pulled from case bank
c. Expert checklist data and diagnoses into database

10. Educational module #1 provided to trainee
a. Trainee completes educational module #1
   i. Provides diagnoses
   ii. Completes criteria checklist, quality checklist, and additional material and study checklist
b. Trainee data entered into database
c. Trainee scored
d. Feedback provided
   i. Trainee completes bias checklist for incorrect diagnoses
   ii. Trainee provided overall score, correct diagnoses, and strengths and weaknesses
   iii. Trainees provided expert criteria and quality checklists for each incorrect diagnosis
   iv. Trainees provided greater feedback on criteria, quality, and additional material and study checklist and the similarities and differences between the expert and trainee completion of the checklists
   v. Trainees provided greater discussion of biases in case
e. Trainees provide opportunity to ask questions
f. Questions answered by expert

11. Educational modules #2-#9 developed and provided to trainee (as above)

12. Trainee may complete the second evaluation module
a. Difficulty of module based on current level of performance

13. Provide additional educational modules

14. Continue population of database by expert reviewing and grading new cases

With reference to the above flowchart, a criteria checklist contains a list of individual criterion. The pathology diagnosis is based on the recognition of the presence or absence of these individual criterions. These individual criterions describe individual cellular characteristics, for example, (e.g., nucleus) and tissue architectural characteristics (e.g., the arrangement, number and location of cells and non-cellular material).

Although the Example section below is focused on cancer based applications of the embodiments herein, the methods and systems can be equally effective at non-neoplastic applications, including, but not limited to: diagnosis of inflammatory conditions of the liver, non-neoplastic lung diseases, and non-neoplastic colon diseases. The term non-neoplastic is used herein to refer to diseases caused by such things as infectious agents, trauma, metabolic conditions, toxic substances (including drugs), auto-immune conditions, genetic disorders, vascular-associated events, and iatrogenic events.

Unless otherwise indicated, all numbers expressing quantities of ingredients, dimensions reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

### EXAMPLES

The following examples are provided for illustrative purposes only and are not intended to limit the scope of the invention.

### Example 1

### Competency Assessment System

Will provide a valid score of all pathologists for general practice and all subspecialties

Will provide a valid score for all trainees

Score: correct, incorrect, don't know (no diagnosis)

### Education System

Case selection and feedback builds model of slow learning (recognizing patterns) to fast learning (pattern recognition) to select slow learning (recognizing heuristics and biases) to self-learning and mastery

Pathologist training levels are master, experienced, novice, and trainee.

### Example 2

### Interpretation Checklist

Diagnosis
1. Made the correct diagnosis (Malignant/Neoplastic vs. Benign):
   □PW□NPW□NP
2. Demonstrated the ability to focus on the specimen appropriately using the available microscope:
   □PW□NPW□NP
3. Demonstrated knowledge of common and required informational elements prior to rendering diagnosis:

a. Examined identifiers (patient and institution)
□PW□NPW□NP

b. Obtained necessary input from the responsible pathologist (if applicable)
□PW□NPW□NP

c. Obtained necessary input from the responsible clinician
□PW□NPW□NP

d. Obtained prior pertinent patient material
□PW□NPW□NP

### Example 3

### Pathologist Module Development

An evaluation and training will be delivered through modules of cases, consisting of slides of individual patient specimens.

### BACKGROUND

### Pathology Practice

Pathologists examine glass slides or digital images of glass slides. Slide preparation involves the completion of a number of process steps: gross tissue examination, dissection, and sectioning of a patient specimen, tissue fixation using formalin, processing (involving tissue dehydration, clearing and infiltration), embedding in paraffin wax, tissue sectioning with placement of thin sections on a slide, staining with histochemical stains that highlight specific features of tissues, and coverslipping. The entire process results in the production of very thin sections.

In pathology practice, at least one slide (and an average of three to seven) is prepared from each tissue specimen. Large numbers of slides (e.g., 50-100) may be produced from some specimens, depending on a number of factors.

The pathologist examines these slides with the aid of a microscope and renders a diagnosis based on the appearance of the tissue. Pathologist practice involves the classification of disease and much of this practice is based on separating benign from malignant lesions and classifying malignant lesions for patient management purposes.

After the initial examination of specimen slides, a pathologist may need to perform additional testing for greater diagnostic clarification. The pathologist may request that additional gross tissue be submitted for processing and/or request the performance of additional histochemical stains, immunohistochemical studies, or molecular-based studies.

These additional studies involve methods to detect specific features or characteristics within tissues and cells. For example, a pathologist may request an “iron” histochemical stain to detect the presence of iron in a cell seen on a slide; or a pathologist may request a keratin immunohistochemical study to demonstrate “reactivity” of cellular components to specific antibodies corresponding to unique cellular differentiation characteristics (specific keratins are observed in specific types of epithelial lesions), or molecular genetic characteristics of cells. These additional or ancillary studies are used for a variety of reasons, such as to characterize tumors (carcinoma versus sarcoma)

The cases used in our modules are from previously examined and diagnosed material in institutional storage. Institutions keep slides for many years for reasons related to patient care considerations, governmental regulations, and for research purposes.

At the current time, a slide may be scanned to produce digital images that may be viewed on a computer monitor and these images have the same resolution and quality as the glass slides. In the United States, vendor technology currently is not licensed for primary diagnostic interpretation because of FDA regulations, which so far, vendors have not satisfied. In Canada, primary diagnostic interpretation most likely will be achieved in 2013. Pathologists often used digital images in diagnostic consultation (secondary diagnostic interpretation).

### Education

Currently, pathologists learn in an apprenticeship-based environment where expert pathologists first teach diagnostic criteria (e.g., architectural or cellular characteristics) observed on a hematoxylin and eosin stained glass slide.

The following list contains examples of these cellular and architectural criteria and the types of lesions in which they are found:

Cellular

Large nuclei—seen in malignancy

Prominent nucleoli—seen in malignancy

Large amount of cytoplasm—seen in benign conditions

Large number of cellular mitoses—seen in malignancy

Hyperchromatic (dark) nucleus—seen in malignancy

Architectural

Cellular overlapping—seen in malignancy

Necrosis (tissue death)—seen in malignancy

Cellular invasion—seen in malignancy

A specific disease may be classified by the specific observable features in the cellular environment and different diseases show an overlap of these features or diagnostic criteria. For example, both benign and malignant conditions may show the same cellular criteria listed above. Diseases are distinguished by combinations of the presence or absence of individual criterion and the variation of individual criterion (e.g., the size of a nucleus may vary but the size of the population of nuclei may have a greater probability to be larger in a specific malignancy). The specific combinations of criterion are often referred to as the pattern of a specific disease.

Presumably, expert pathologists recognize the subtly of criteria and patterns and are better able to differentiate diseases. Pathologists also use other forms of information, such as clinical information or ancillary testing (e.g., immunohistochemical studies) to assist in making a specific diagnosis.

In early learning, pathologists first look carefully at slides and identify individual criterion and patterns and assimilate other information. These novices learn to match these cognitively assessed data points to a specific disease. This is the process of learning pattern recognition. Kahneman and Tversky characterized this cognitive process as slow thinking, which consists of a rational, deliberate, methodical, and logical process of reaching a solution to the problem of accurately classifying the disease. Kahneman and Tversky is incorporated by reference in its entirety.

As pathologists become more experienced, they see the criteria and patterns quicker and the diagnosis becomes more based on pattern recognition rather than assessing individual criterion one by one. In the process of pattern recognition, we use a heuristic or a mental short cut to move from criteria to pattern to disease. A pathologist will quickly recognize that a specific pattern is present and therefore the associated specific disease also is present.

Heuristics are simple, efficient rules, which explain how people make decisions, come to judgments, and solve problems, typically when facing complex problems or incomplete information.

Kahneman and Tversky characterized this cognitive process as fast thinking, which we use most of the time, each day. Kahneman uses the example of driving home from work to illustrate how we constantly use fast (driving process) thinking, but do not rationally examine each step in the process (e.g., do I turn the steering wheel five degrees to the right to turn right at the next road).

If experienced pathologists encounter a challenging case (see below) they may move away from fast thinking to slow thinking and more rationally analyse the criteria and patterns of a case. In this example, they may recognize that the pattern that they see does not match with a specific disease and that they need to think more carefully about the information before rendering a definitive diagnosis.

Until now, pathologists have studied diagnostic criteria and patterns and recognize that much of their work involves pattern recognition. Some pathologists have developed technology that recognizes some patterns as an aide to diagnosis (in the field of Pap test cytopathology). However, little to no work has been performed to apply the fast and slow thinking principles to pathology.

### Diagnostic Cognitive Error

Causes of pathologist cognitive error include failures in attention, failures in memory, failures in knowledge and failures in heuristics (or bias). Some cognitive theorists also believe that failures in attention, memory, and knowledge also are forms of bias, reflecting a bias in our not knowing we are not paying attention, or that we have forgotten, or that we never knew in the first place. In other words, these biases reflect that we are not being cognizant of our individual propensity that we fail (e.g., we link that our belief is true and have assessed that we are paying attention or that we know the answer).

A bias in pathologist cognition is when the rules of pattern recognition fail and the correct link between the pattern and the diagnosis is not made. Cognitive psychologists have generated a number of biases and Table 1—Bias Checklist categorizes 35 main biases and provides pathology examples. Our research indicates that these 35 biases are the predominant biases in diagnostic interpretation.

TABLE 1
Bias Checklist

| Bias | Definition | Pathology Example | Questions |
|---|---|---|---|
| Ambiguity | The tendency to avoid | Biopsy shows mild biliary | Did you have enough |
| effect bias | options for which | changes and nothing else | data to make diagnosis? |
| | missing information | but no LFTs are available. | Was information |
| | makes the probability | Dx of biliary disease is | missing? |
| | seem “unknown.” | avoided because no labs | |
| | | can support mild findings. | |
| Anchoring bias | The tendency to rely | Pathologist saw a case of | Did you focus on one |
| | too heavily, or | HCV and so will force | thing (criterion, |
| | “anchor,” on one trait, | criteria/pattern into HCV. | criteria, IHC study) and |
| | past reference, or | | ignore others? |
| | piece of information | | |
| | when making | | |
| | decisions. | | |
| Recency bias | A cognitive bias that | Another type of | Did you put too much |
| | results from | anchoring where the past | weight on a recently |
| | disproportionate | reference is the cause of | seen case? |
| | salience of recent | the anchor. Especially if | |
| | stimuli or | we just saw it. | |
| | observations - the | | |
| | tendency to weigh | | |
| | recent events more | | |
| | than earlier events. | | |
| Subjective | Perception that | In pathology I think this | Did you think it was x |
| validation bias | something is true if a | may be a severe type of | because it “looked x? |
| | subject's belief | anchoring where | |
| | demands it to be true. | something (history, | |
| | Also assigns | clinician impression, | |
| | perceived connections | radiology) makes you | |
| | between coincidences. | certain about a case even | |
| | | before you have looked at | |
| | | the slides. Connections | |
| | | between coincidences | |
| | | applies in the saying | |
| | | “things come in threes” | |
| | | meaning you may see 3 | |
| | | cases of an odd disease in | |
| | | close succession. | |
| Selective | The tendency for | Another anchoring bias. | Did you perceive this to |
| perception bias | expectations to affect | Yes, like if we expect | be x because you |
| | perception. | certain criteria to be | expected to be x? |
| | | present, we find them. | For example, did you |
| | | Like expecting to see LVI | call it benign because |
| | | and then seeing it. | the patient was young? |
| Expectation | The tendency for | This is a type of anchor | Did you downgrade |
| bias | experimenters to | bias. May partially | criteria or upgrade |
| | believe, certify, and | explain why experts | criteria to support your |
| | publish data that | disagree with other | expectation? |
| | agree with their | experts. | |
| | expectations for the | | |
| | outcome of an | | |
| | experiment, and to | | |
| | disbelieve, discard, or | | |
| | downgrade the | | |
| | corresponding | | |
| | weightings for data | | |
| | that appear to conflict | | |
| | with those | | |
| | expectations. | | |
| Frequency | The illusion in which | I think this is another | Did you make the dx |
| illusion bias | a thing that has | anchoring bias in which | because new |
| | recently come to one's | you are made aware of | information came to |
| | attention suddenly | new criteria or finding | your attention - just |
| | appears “everywhere” | and now overcall it over | read about it or went to |
| | with improbable | and over. | a meeting? |
| | frequency. | | |
| Attention bias | The tendency to | A small and fragmented | Did you neglect |
| | neglect relevant data | biopsy is called stage 2 | specific criteria because |
| | when making | fibrosis because the | of the associations of |
| | judgments of a | fragmentation makes | other criteria and the dx |
| | correlation or | interpretation difficult. | (e.g., mitoses = |
| | association. | Trainee knows cirrhosis is | malignancy and neglect |
| | | associated with low | inflammation)? |
| | | platelets and decreased | |
| | | synthetic function, as is | |
| | | present in this case, but | |
| | | ignores them to issue | |
| | | diagnosis of stage 2. | |
| Availability | Estimating what is | Trainee was recently | Was a similar case |
| heuristic bias | more likely by what is | embarrassed by a | (emotionally charged) |
| | more available in | consultant who disagreed | remembered? |
| | memory, which is | on a hepatocellular lesion | |
| | biased toward vivid, | and called it HCC while | |
| | unusual, or | the trainee called it | |
| | emotionally charged | benign. Trainee is now | |
| | examples. | more likely to call HCC | |
| | | on any hepatocellular | |
| | | lesions, regardless of | |
| | | criteria. This is how our | |
| | | individual “thresholds” | |
| | | are altered over time in | |
| | | training and is influenced | |
| | | by colleagues. So and so | |
| | | always calls dysplasia so | |
| | | a department may | |
| | | decrease threshold for | |
| | | CIN I over time. | |
| Backfire effect | Evidence | Liver biopsy shows | Did you choose a |
| bias | discontinuing our | lymphoplasmacytic | diagnosis even though |
| | beliefs only | hepatitis suggestive of | you had evidence |
| | strengthens them. | AIH. Labs are totally | disconfirming that |
| | | negative for AIH features. | diagnosis? |
| | | Now we feel more | |
| | | strongly than before that it | |
| | | is a case of AIH. | |
| Bandwagon | The tendency to do | You feel strongly a case | Did you miss the |
| effect | (or believe) things | is carcinoma and show it | diagnosis because |
| | because many other | to your colleagues. None | others told you that |
| | people do (or believe) | of them are willing to call | specific criteria (you |
| | the same. Related to | it and so you sign it out as | saw) are not important? |
| | groupthink and herd | atypical. | |
| | behavior. | Clinical services seem not | |
| | | to care about fibrin | |
| | | thrombi in glomeruli at | |
| | | time 0 kidney biopsies. | |
| | | You then stop reporting | |
| | | it, even though it is a | |
| | | feature of acute AMR. | |
| Base rate | The tendency to base | 90% of breast masses in | Did you ignore the |
| neglect bias | judgments on | women under 30 are FA | statistical probability of |
| | specifics, ignoring | and benign. You have a | the diagnosis (rare or |
| | general statistical | biopsy that shows a very | common) because you |
| | information. | focal proliferative area on | were certain that |
| | | the edge of the biopsy in a | specific criteria |
| | | 25 year old. You call it | represented that |
| | | ADH despite the base rate | disease? |
| | | of FA in this population. | |
| Conjunction | The tendency to | We might reinforce this | Did you overcall a |
| fallacy bias | assume that specific | bias with simulation | disease (UC) instead of |
| | conditions are more | training modules because | leaving it as a general |
| | probable than general | they artificially increase | category |
| | ones. | the probability of | (inflammation)? |
| | | encountering more rare | |
| | | diagnoses and diseases. | |
| | | We need to reinforce this | |
| | | idea of probability of an | |
| | | HCV case is far more | |
| | | likely than glycogenic | |
| | | hepatopathy. | |
| Neglect of | The tendency to | What is more likely to | Were you uncertain |
| probability bias | completely disregard | come across your desk, a | about this case and then |
| | probability when | FA or invasive carcinoma | completely disregarded |
| | making a decision | in a 25 year old woman? | the probability of your |
| | under uncertainty. | This probability should | diagnosis? |
| | | play a role but it does not. | |
| | | This seems similar to the | |
| | | Base Rate Bias but this is | |
| | | ignoring probability in | |
| | | uncertainty while base- | |
| | | rate is ignoring | |
| | | probability in a specific | |
| | | finding. Neglect of | |
| | | probability is likely more | |
| | | frequent. | |
| Belief bias | An effect where | Breast biopsy submitted | Did you justify your |
| | someone's evaluation | by radiologist as 5 cm | diagnosis because you |
| | of the logical strength | speculated mass with | believed in it rather |
| | of an argument is | calcifications. Breast | than on criteria you |
| | biased by the | cancer. You trust the | saw? |
| | believability of the | radiologist based on your | |
| | conclusion. | experience and she is | |
| | | “never” wrong. You | |
| | | believe this is cancer | |
| | | before you look at the | |
| | | slides and will have a | |
| | | higher confidence level in | |
| | | your interpretation of the | |
| | | “malignant” criteria. In a | |
| | | simulation scenario you | |
| | | just missed a case of AIH | |
| | | and believe you will be | |
| | | given a case of AIH to | |
| | | further your | |
| | | understanding on the next | |
| | | set of cases and over | |
| | | interpret a case of HCV as | |
| | | AIH (also a component of | |
| | | availability bias). This | |
| | | has more to do with a bias | |
| | | related to your confidence | |
| | | in the logic of how you | |
| | | arrived at a diagnosis | |
| | | rather than availability. | |
| Bias blind spot | The tendency to see | “I'm going to call it | |
| | oneself as less biased | reactive because Dr. | |
| | than other people. | Smith is biased by that | |
| | | last case he was burned | |
| | | on and now ALWAYS | |
| | | calls it malignant. I'm not | |
| | | going to follow his bias!” | |
| | | Often used by experts | |
| | | when discounting other | |
| | | experts. | |
| Choice- | The tendency to | A criteria on a checklist is | |
| supportive bias | remember one's | checked (atypical | |
| | choices as better than | epithelial cells). Trainee | |
| | they actually were. | recalls plenty of features | |
| | | that supported the criteria. | |
| | | Now on review there is | |
| | | only one (pleomorphic) | |
| | | that applies. | |
| Clustering | The tendency to see | Trainee describes | Did you see a pattern |
| illusion bias | patterns where | “classic” nodular | where none really |
| | actually none exist. | aggregates of | exists? |
| | | lymphocytes in a portal | |
| | | area in a case of HCV. It | |
| | | is a case of HCV but the | |
| | | infiltrate is diffuse, not | |
| | | nodular. | |
| Confirmation | The tendency to | The clinical history is | Did you have a |
| bias | search for or interpret | classic for PBC. Minimal | preconception before |
| | information in a way | biliary changes are | you fully looked at the |
| | that confirms one's | interpreted as consistent | case and then confirm |
| | preconceptions. | with PBC while the | the preconception |
| | | interface and | based on patterns you |
| | | centrolobular | identified |
| | | necroinflammatory injury | |
| | | of AIH is completely | |
| | | ignored. Kind of the | |
| | | opposite of Attention | |
| | | bias. | |
| Congruence | The tendency to test | IPR reveals a case of | Did you think of one |
| bias | hypotheses | HCV. You then search | diagnosis (or a few |
| | exclusively through | for criteria to support | diagnoses) and then |
| | direct testing, in | HCV rather than | looked for criteria for |
| | contrast to tests of | searching for criteria to | that diagnosis rather |
| | possible alternative | evaluate for the spectrum | than consider other |
| | hypotheses. | of liver diseases (blood | diagnoses? |
| | | flow, SH, AIH, biliary). | |
| | | This is a very common | |
| | | bias because we jump to | |
| | | gestalt diagnoses quickly. | |
| | | Some of the best teachers | |
| | | I have experienced have | |
| | | emphasized patterns, | |
| | | completeness, and not | |
| | | jumping to a diagnosis | |
| | | (Jake). This is really a | |
| | | KEY bias in my opinion. | |
| | | Also like ordering IHC to | |
| | | rule out a disease. | |
| Contrast bias | The enhancement or | A trainee sees 2 | Did you contrast this |
| | diminishing of a | consecutive cases of HCV | case with a recently |
| | weight or other | with fibrosis. The first is | seen case and then |
| | measurement when | cirrhosis and the second is | made the diagnosis |
| | compared with a | stage 2 with early | based on its similarity |
| | recently observed | bridging. Because the | or difference to this |
| | contrasting object. | fibrosis is so much less | recent case? |
| | | than the first, the second | |
| | | is interpreted as having no | |
| | | fibrosis at all (in | |
| | | comparison). | |
| Distinction bias | The tendency to view | Similar to contrast bias | Did you make this |
| | two options as more | above. An example may | diagnosis by |
| | dissimilar when | be comparing 2 | considering two |
| | evaluating them | intraductal proliferations | diagnoses and then |
| | simultaneously than | on the same case and | distinguishing them |
| | when evaluating them | calling one significantly | from each other? |
| | separately. | more atypical than the | |
| | | other when they are | |
| | | actually similar. | |
| Do no harm | Judgment based on | Reluctance to call cancer | Did you make this |
| bias | reducing risk of major | in a pancreas biopsy | diagnosis because you |
| | harm. | because of the extreme | thought it would be less |
| | | surgery that will be | risky to the patient if |
| | | performed on a positive | you were wrong? |
| | | case. Refusal to evaluate | |
| | | a frozen section of a soft | |
| | | tissue lesion because you | |
| | | do not want an | |
| | | amputation performed on | |
| | | its result. | |
| Empathy bias | The tendency to | Think of when a | Did you make this |
| | underestimate the | colleague shows you a | diagnosis because you |
| | influence or strength | case and says it is benign | underestimated how |
| | of feelings, in either | and you think “no way” | your feelings |
| | oneself or others. | but then you say, “I'm | influenced you? |
| | | worried - at least | |
| | | atypical.“ Or not | |
| | | challenging the Big Dog. | |
| | | The lack of proficiency | |
| | | testing in our field has to | |
| | | do with the feelings we | |
| | | have for others (we don't | |
| | | want to expose someone | |
| | | as incompetent) as well as | |
| | | the fear in ourselves. | |
| Focusing bias | The tendency to place | Focus too much on one | Did you focus too much |
| | too much importance | small finding or criteria | on a single or small |
| | on one aspect of an | and allow it to bias the | group of criteria? |
| | event; causes error in | interpretation of the | |
| | accurately predicting | whole case. This is | |
| | the utility of a future | classic in cases where one | |
| | outcome. | of bile ducts look slightly | |
| | | abnormal and the | |
| | | pathologist puts the case | |
| | | in a biliary pattern. This | |
| | | bias is “don't put all your | |
| | | eggs in one basket of | |
| | | findings.” Back up and | |
| | | ask your-self the general | |
| | | pattern. Like the gorilla | |
| | | in the video. Also events | |
| | | such as focusing on the | |
| | | epithelial margin and | |
| | | ignoring the deep margin. | |
| Framing bias | Drawing different | We are subject to this | Did you make the |
| | conclusions from the | when we read clinical | diagnosis based on how |
| | same information, | history. The way it is | the case (pictures or |
| | depending on how | presented by the clinician | history) were |
| | that information is | frames it in a way that is | presented? |
| | presented. | suggesting a particular | |
| | | finding. When signing | |
| | | out with a resident they | |
| | | also frame a case for us | |
| | | by suggesting a diagnosis. | |
| | | When we are showing a | |
| | | case to a resident we are | |
| | | framing it a particular | |
| | | way to suggest a | |
| | | particular diagnosis. | |
| | | Maybe we need to watch | |
| | | the resident drive the | |
| | | scope to help us | |
| | | understand what they are | |
| | | really seeing? Yes, frame | |
| | | in many ways - by the | |
| | | institution where you | |
| | | trained, by the clinician | |
| | | who sends you a specific | |
| | | case type, and even by a | |
| | | consult from a colleague | |
| | | who you know shows you | |
| | | “malignant” cases. | |
| | | Blinded review removes | |
| | | some framing and creates | |
| | | others. | |
| Information | The tendency to seek | This can be a bias that | Did you mot make a |
| bias | information even | may slow down a sign-out | diagnosis because you |
| | when it cannot affect | process and lead to delays | wanted more |
| | action. | in diagnosis. Sometimes | information, even |
| | | it is what it is and no | though you know the |
| | | information will change | additional information |
| | | that. Or over-ordering | would not affect the |
| | | IHC. | diagnosis? |
| Irrational | The phenomenon | Insistence that the criteria | Did you spend a lot of |
| escalation bias | where people justify | for malignancy is there | time in thinking about |
| | increased investment | despite no cancer being | this and make your |
| | in a decision, based | present on the resection. | judgment based on time |
| | on the cumulative | Or discounting IHC | spent, rather than the |
| | prior investment, | results as the criteria were | findings? |
| | despite new evidence | obvious on light | |
| | suggesting that the | microscopy. | |
| | decision was | | |
| | probably wrong. | | |
| Mere exposure | The tendency to | This is a classic bias of | Did you make this |
| bias | express undue liking | why we “like” certain | diagnosis because you |
| | for things merely | specialties instead of | have seen examples of |
| | because of familiarity | others, because we are | this disease before and |
| | with them. | more familiar with them. | thought it looked |
| | | This is an excuse for not | similar? |
| | | knowing other specialties | |
| | | and suggests we ought to | |
| | | do a simulation module | |
| | | on it [symbol] . Or in training | |
| | | you work with a guru | |
| | | who sees all the | |
| | | neuroblastomas and after | |
| | | training, you begin to | |
| | | overcall neuroblastoma | |
| | | because you are familiar | |
| | | with it and “like” being a | |
| | | neuroblastoma expert. | |
| | | May explain why certain | |
| | | thyroid experts also | |
| | | corroborate what you | |
| | | think they will say. | |
| Negativity bias | The tendency to pay | If you made an error you | Did you make this |
| | more attention and | put more weight on the | diagnosis because you |
| | give more weight to | miss (I'm never going to | did not want to make |
| | negative than positive | miss a tall cell papillary | another diagnosis out of |
| | experiences or other | carcinoma again) and | fear of being wrong? |
| | kinds of information. | begin to overcall thyroid | |
| | | FNAs as “atypical” even | |
| | | though the criteria are not | |
| | | really present. | |
| Observer- | When a researcher | A clinician tells you he | Did you expect a result |
| expectancy | expects a given result | thinks the dx is PBC. | and therefore, |
| effect bias | and therefore | You interpret the case as | misinterpret the data, |
| | unconsciously | PBC in spite of criteria | such as IHC? |
| | manipulates an | that support another | |
| | experiment or | disease. Or you think the | |
| | misinterprets data in | disease is | |
| | order to find it | hemochromatosis on | |
| | | some criteria and interpret | |
| | | the iron to support that dx. | |
| Omission bias | The tendency to judge | A false positive diagnosis | |
| | harmful actions as | of malignancy that leads | |
| | worse, or less moral, | to radical surgery is | |
| | than equally harmful | worse than a false | |
| | omissions (inactions). | negative diagnosis in | |
| | | which a patient dies years | |
| | | earlier that they would | |
| | | have due to more | |
| | | advanced disease. The | |
| | | outcome is actually worse | |
| | | in the false negative case. | |
| Outcome bias | The tendency to judge | This is a classic | |
| | a decision by its | retrospective bias and is | |
| | eventual outcome | strongly at play in | |
| | instead of based on | medicolegal cases. It is | |
| | the quality of the | “easy” intellectually to | |
| | decision at the time it | see the malignant cells in | |
| | was made. | a biliary brushing after | |
| | | the patient has had a | |
| | | Whipple that shows | |
| | | adenocarcinoma. | |
| Hindsight bias | The tendency to see | I see this similar to the | |
| | past events as being | outcome bias but without | |
| | predictable at the time | the component of follow- | |
| | those events | up information. We do | |
| | happened. | this all the time when we | |
| | | say, “I can see what they | |
| | | may have been thinking | |
| | | and why they made that | |
| | | diagnosis.” Or, “I can see | |
| | | that the pathologist made | |
| | | an error because the | |
| | | diagnosis should have | |
| | | been obvious | |
| | | (predictable).” This is a | |
| | | typical medical-legal | |
| | | expert fallacy and | |
| | | ignoring system latent | |
| | | factors. Many | |
| | | pathologists are biased in | |
| | | that they believe they | |
| | | could have handled cases | |
| | | differently than they did. | |
| Overconfidence | Excessive confidence | This is part of the Big- | Were you overly |
| effect bias | in one's own answers | Dog effect. The Big- | confident that you were |
| | to questions. | Dogs are supremely | correct? |
| | | confident because they | |
| | | are never challenged. | |
| | | They cannot be wrong | |
| | | because they are the best | |
| | | at what they do. As | |
| | | expertise increases the | |
| | | risk of this bias increases | |
| | | and makes mistakes in | |
| | | this bias potentially more | |
| | | drastic. Or you think that | |
| | | you learned what the Big | |
| | | Dog taught you at a | |
| | | meeting and now you are | |
| | | overconfident in your | |
| | | ability. | |
| Planning | The tendency to | Has more to do with turn- | |
| fallacy bias | underestimate task- | around time and the belief | |
| | completion times. | that it takes less time to | |
| | | complete cases then it | |
| | | actually does. | |
| Pseudocertainty | The tendency to make | It depends what we | Did you use an |
| effect bias | risk-averse choices if | perceive to be the | indeterminate in order |
| | the expected outcome | outcomes. If we avoid an | to not overcall or under |
| | is positive, but make | outcome of missing an | call another diagnosis? |
| | risk-seeking choices | HSIL by overcalling Pap | |
| | to avoid negative | tests we are actually risk | |
| | outcomes. | seeking (in terms of | |
| | | patients). | |
| Semmelweis | The tendency to reject | This may be a more | |
| reflex bias | new evidence that | global bias but applies | |
| | contradicts a | when a new | |
| | paradigm. | grading/staging system is | |
| | | introduced that is based | |
| | | on new evidence and is | |
| | | different than the current | |
| | | system. Or even a new | |
| | | pathologic diagnosis | |
| | | contradicts and existing | |
| | | one - like the | |
| | | helicobacter controversy. | |
| Wishful | The formation of | This is probably in play | Did you make the |
| thinking bias | beliefs and the | when we assign criteria to | diagnosis because you |
| | making of decisions | diagnosis we have made | wanted the case to be X |
| | according to what is | even when the criteria are | and not really pay |
| | pleasing to imagine | not well characterized on | attention to criteria? |
| | instead of by appeal | the particular case. An | |
| | to evidence or | example would be an | |
| | rationality. | FNH that does not have | |
| | | clearly aberrant arteries | |
| | | on the biopsy but because | |
| | | we like to have our cases | |
| | | fit criteria well we might | |
| | | point to a tangentially | |
| | | sectioned artery and | |
| | | suggest it is aberrant. | |
| Zero-risk bias | Preference for | Interpreting a case and | Did you make a less |
| | reducing a small risk | releasing a report is taking | definitive diagnosis |
| | to zero over a greater | a risk. There are risks to | because you were |
| | reduction in a larger | the patient and risks to | afraid on being wrong |
| | risk. | you professionally (what | with a more specific |
| | | the clinicians will think of | diagnosis? |
| | | you, medicolegal). | |
| | | Calling a difficult case | |
| | | atypical instead of cancer | |
| | | is reducing your | |
| | | medicolegal risk (a small | |
| | | risk compared to patient | |
| | | care) to near zero but is | |
| | | not going to have a | |
| | | greater effect on the | |
| | | patient risk (if they have | |
| | | cancer, the sooner | |
| | | diagnosed and treated the | |
| | | better). | |

Embodiments herein, as applied to pathology, are unique and the method by which we apply it to training and evaluation is novel, providing surprising results. Much of the pathology literature and textbooks stress the importance of learning criteria and there is some emphasis on combinations of criterion for the diagnosis of specific diseases. Currently, there is no application of any cognitive failure theory to pathology diagnostic error as a means to improve.

The data in the pathology literature indicate that an error in diagnosis occurs in approximately 2% to 5% of pathology cases.

In the field of patient safety, most medical errors are slips or mistakes in processes that go unnoticed or unchecked and occur because of failures in fast thinking. When medical practitioners use slow thinking, the frequency of errors is decreased.

Most pathology cognitive diagnostic errors also are secondary to slips and mistakes during fast thinking processes. Failures in attention, memory slips, and recognizing lack of knowledge also occur during fast thinking processes and most likely are specific types of biases such as gaze bias (we do not pay attention to our work) or overconfidence bias (we think we know something when we really do not).

Our research findings indicate that one or more biases are associated with all cognitive diagnostic errors. We also have found that specific biases may be recognized in hindsight by pathologists who committed the error or by a mentor who asks specific questions to determine the specific bias.

### Principles of Our Simulation Evaluation and Training

### Case Bank for Evaluation and Training Modules

Evaluation and training modules are constructed by selecting individual cases from a case bank. Case banks can have thousands of cases representing all different types of diseases in their various presentations. For our initial testing, we have been working with case banks of approximately 1,000 cases. For example, we have developed a case bank of approximately 1,000 breast biopsy specimens and 1,200 liver biopsy specimens for the breast and liver subspecialty training modules. The steps we use in overall module development are shown in Table 2—Simulation Steps.

TABLE 2
Simulation Steps

Simulation Steps
Step responsibility:

MLCI: Medicolegal Consultants International, LLC, for example
Ex: Content expert
HC: Healthcare entity employing expert

MLCI - Expert Assessment
Identify expert or groups of experts (generally based on subspecialty) (MLCI)
Identify specific subspecialty based on perceived need of module development (MLCI)
Communicate with expert to determine level of agreement to participate (MLCI)
Obtain agreement/permission of HC employing expert (Ex)
Communicate with HC regarding participation (MLCI + Ex)
Communicate with HC on level of expected financial support (MLCI + Ex)
Confidentiality agreement signatures (Ex)
Expert Content Assessment
Determine ability of expert to provide content (MLCI)

Provide data on current cases immediately available, e.g., existing study sets (Ex)

Number of cases (Ex)
Information content in existing data sets, e.g., patient characteristics (Ex)
Categorization of diagnosis, e.g., benign vs. malignant (by volume) (Ex)

Categorization of diagnostic subclassification, e.g., types of malignancy

(by volume) (Ex)

Iterative subclassification, e.g., subtypes of specific malignancy (if
necessary) (Ex)

Report on degree in which cases are ranked by difficulty (Ex)

Initial assessment of sufficiency of content (MLCI)

Content gap analysis (MLCI)
Quality of data set analysis (MLCI)
Assessment decision, yes, no or more data needed (MLCI)

Provide data on current cases available through additional collection methods (Ex)

Number of cases (Ex)
Information content in existing data sets, e.g., patient characteristics (Ex)
Categorization of diagnosis, e.g., benign vs. malignant (by volume) (Ex)

Categorization of diagnostic subclassification, e.g., types of malignancy

(by volume) (Ex)

Iterative subclassification, e.g., subtypes of specific malignancy (if
necessary) (Ex)

Report on degree in which cases are ranked by difficulty (Ex)

Final assessment of sufficiency of content (MLCI)

Content gap analysis (MLCI)
Quality of data set analysis (MLCI)
Assessment if additional content necessary (MLCI)
Assessment of ability of expert to obtain outside content (MLCI)
Assessment decision on expert content, yes, no or more data needed (MLCI)

Iterative process of all above steps to determine if additional Expert(s) required (MLCI)
Reach agreement of expert participation (MLCI + Ex)
Module Development
Expert deidentifies cases (Ex)
Expert scans or makes available all slides for digital imaging (DI) scanning (Ex or MLCI)
Expert creates database of individual case characteristics (Ex)
Accrue additional cases beyond current capacity of expert (Ex + MLCI)
Assemble additional cases as above (Ex)
Expert and MLCI devise checklist for diagnostic criteria (MLCI + Ex)
Expert provides unique criteria (if any) of each case (Ex)
MLCI provides case difficult scale based on frequency of disease, quality of sample, and
additional criteria (MLCI)
Expert approves case difficulty scale (Ex)
Expert grades cases by difficulty and type of difficulty (Ex)
MLCI evaluates all cases submitted by Expert (MLCI)
MLCI performs validation of case difficulty assessment (MLCI)
MLCI identifies gaps in case types (MLCI)
MLCI requests additional cases be provided (MLCI)
Additional cases provided (Ex)
IT delivery system created (MLCI - Patent)
Proficiency testing system created (MLCI - Patent)
Educational delivery modules created (MLCI - Patent)
Educational assessment system created (MLCI - Patent)
Pilot subjects identified (Ex)
Validity testing of proficiency testing performed (Ex + MLCI)
Changes made in system to improve validity (MLCI)
Re-testing of validity of proficiency testing performed (Ex + MLCI)
Iterative process of validity testing performed until sufficient validity reached (Ex + MLCI)
Validity testing of educational modules performed (Ex + MLCI)
Changes made in system to improve validity (MLCI)
Re-testing of validity of educational modules performed (Ex + MLCI)
Iterative process of validity testing performed until sufficient validity reached (Ex + MLCI)
Validity testing of educational assessment performed (Ex + MLCI)
Changes made in system to improve validity (MLCI)
Re-testing of validity of proficiency testing performed (Ex + MLCI)
Iterative process of educational assessment performed until sufficient validity reached (Ex +
MLCI)
Additional case accrual performed (Ex) (as identified by MLCI and Ex)
Re-evaluation of case mix and difficulty performed as necessary (Ex)
Beta testing subjects identified (Ex)
Beta testing performed in subject populations (e.g., residents, practicing pathologists of various
levels of expertise) (MLCI + Ex)
Additional case accrual performed (Ex) (as identified by MLCI and Ex)
Re-evaluation of case mix and difficulty performed as necessary (Ex)
Modular content deemed ready for use (MLCI - P)

The case bank is matched with a database, including the following data elements for each case:

Deidentified case number

Clinical history
Patient gender
Patient age
Physical examination features
Radiologic features
Additional pertinent history (e.g., radiation)
Previous relevant clinical diagnoses
Previous relevant pathology diagnoses

Number of slides (images) with case

Original pathology diagnosis

Expert pathology diagnosis

Criteria checklist features—completed by content expert pathologist (see below)

Expert assessment of case representativeness (1-5 Likert scale)

Expert assessment of case quality (1-5 Likert scale)

Expert assessment of commonness of case (1-5 Likert scale)

Additional material and study checklist (Table 3)

Checklist of common biases (Table 1)

Follow-up pathology diagnoses (if any)

TABLE 3
Checklist for Ancillary Stains and Additional Material

| Recuts | |
|---|---|
| Levels | |
| Unstained | |
| Re-embed | |
| Re-cut for Collection | |
| Other Requests | |
| Routine Stains | |
| □ Alcian blue/PAS | □ Kinyoun |
| □ Alcian blue pH 1.0 | □ Luxol fast blue |
| □ Alcian blue pH 2.5 | □ Masson Trichrome |
| □ Auramine | □ M-MAS |
| □ Bielschowsky | □ Mucicarmine |
| □ Bilirubin | □ Oil red O |
| □ Colloidal Iron | □ Orcein |
| □ Congo red | □ PAS with diastase |
| □ Cresyl Violet | □ PAS without diastase |
| □ Diff Quick | □ PAS-F |
| □ Fontana-Masson Silver | □ PTAH |
| □ Gallyas | □ Prussian blue |
| □ Giemsa | □ Reticulin |
| □ GMS | □ Sudan Black B |
| □ Gomori's Trichrome | □ Toluidine Blue |
| □ Gram | □ Verhoeffs elastic |
| □ Grimelius | □ Von Kossa |
| □ JMS | □ Warthin Starry |
| □ Jones Silver Stain | |

The expert pathologists and MLCI pathologists work jointly to select cases for the case bank and will include at least 50-100 examples of all disease entities. Some rare diseases may not have this number of examples.

Difficult cases generally fall within three categories:
1. Common disease with unusual presentations (degree of representativeness) (see Table 4—Degree of Representativeness)
2. Common disease with quality artifacts that result in a more challenging interpretation (see Table 5—Quality Artifacts)
3. Rarer disease

A list of pulmonary disease, with examples of rare cases, is shown in the Table 6—Pulmonary Disease Module.

TABLE 4
Degree of Representativeness

Cellular features

Nuclear features

Membrane contour
Size
Chromatin appearance
Nucleolar structure
Mitotic rate and appearance

Cytoplasmic features

Amount
Membrane appearance
Staining tincture
Presence of vacuoles/material
Cohesion

Apoptosis

Relationship to other tumor cells

Single cells
Clusters of cells

Size of group difference
Formation of structures

Glands
Papillary structures
Cords
Sheets
Combinations

Stromal appearance

Fibrosis

Desmoplasia
Dense fibrosis

Necrosis
Inflammation
Vascular proliferation
Vascular invasion

Immunohistochemical appearance

Reactivity with variable antibodies
Different strength of reactivity

TABLE 5
Quality Artifacts

Clinical sampling

Small amount of tumor
Bloody specimen
Necrotic specimen
Crushing or distortion
Freeze artefact
Heat artifact
Chemical artifact

Specimen preparation

Pre-fixation

Air-drying or degenerated specimen
Heat damage
Sutures
Cellulose contamination
Gelfoam artifact
Starch contamination
Catheter damage
Crush
Necrosis
Tattoo pigment
Dyes
Pad artifact
Freezing damage
Misidentification error (e.g., floater)

Bone dust
Incorrect choice of material
Fixation artifacts
Streaming
Zonal
Formalin pigment
Mercury pigment

Over decalcification
Insufficient decalcification

Tissue processing artifacts
Vessel shrinkages
Poor processing

Expired reagents
Inappropriate choice of reagents
Too short processing
Mechanical failure
Solvent failure

Loss of soluble substances

Cholesterol
Neutral lipid

Nuclear meltdown
Myocardial fragmentation
Perinuclear shrinkage
Microtomy
Knife lines

Displaced tissue
Coarse chatter
Venetian blind effect
Roughing holes
Tidemark due to adhesive
Skin contamination
Folds
Bubbles
Contamination
Insufficient depth
Too much depth and loss of tissue

Staining

Residual wax
Incomplete staining
Stain deposits
Unstained
Contamination
Incorrect stain

Coverslipping

Bubbles
Contamination
Mounting media too thick
Not enough mounting media

Preservation

Drying
Water damage
Mount breakdown
Beaching

Ancillary test failures

Immunohistochemical
Molecular
Electron microscopic

TABLE 6
Pulmonary Disease Module

Benign diseases
Lung responses to stimuli

Pneumonia

Acute
Chronic

Interstitial pneumonia
Diffuse alveolar damage
Interstitial pneumonia
Localized fibrosis
Interstitial fibrosis
Emphysema
Hemorrhage
Edema
Eosinophilic pneumonia
Hypertension

Congenital and developmental

Trachea - Rare

Tracheal stenosis
Tracheal agenesis
Tracheomalacia
Tracheoesophageal fistula
Tracheobronchiomegaly

Bronchi - Rare

Bronchomalacia
Bronchofistulas
Bronchogenic cyst

Lung parenchyma
Herniation

Agenesis
Hypoplasia
Horeshoe
Extralobar sequestration
Congenital lobar emphysema
Congenital pulmonary lymphangiectasis
Congenital cystic malformation
Polyaveolar lobe

Acquired neonatal

Hyaline membrane disease
Bronchopulmonary dysplasia
Interstitial pulmonary emphysema
Pulmonary hemorrhage
Idiopathic pulmonary hemosiderosis- Rare
Goodpasture's syndrome- Rare
Vasculitides- Rare
Infections

Viral

Cytomegalovirus
Herpes simples
Varicella-Zoster
Rubella- Rare
Respiratory syncytial virus
Papillomavirus
HIV

Bacteria

Lysteria
Group B beta-hemolytic streptococcus
Mycoplasma

Treponema

Congenital syphilis- Rare

Chlamydia
Parasite

Toxoplasma

Fungal

Peripheral cysts- Rare
Intralobar sequestration
Inflammatory pseudotumor- Rare
Trauma

Physical force
Aspiration
Obstruction

Neoplasms (see below)

Infection

Pneumonia

Acute
Chronic
Abscess
Bronchiectasis
Bronchiolitis obliterans

Agents (varieties of each agent not listed)

Bacteria
Fungal
Viral
Rickettisal
Chlamydia
Parasite- Rare
Pneumocystis

Iatrogenic
Eosinophilic diseases

Asthma
Acute eosinophilic pneumonia
Chronic eosinophilic pneumonia
Mucoid impaction
Bronchocentric granulomatosis- Rare
Allergic aspergillosis
Hypersensitivity
Extrinsic alveolitis- Rare
Histiocytosis X

Sarcoidosis
Vascular

Wegener's granulomatosis- Rare
Allergic granulomatosis and angiitis- Rare
Necrotizing sarcoid granulomatosis- Rare
Angiocentric lymphoproliferative processes- Rare
Lymphomatoid granulomatosis- Rare
Polyarteritis nodosa- Rare
Hypersensitivity vasculitis
Infections
Drugs
Behcet's disease- Rare
Hypertension
Edema
Emboli
Thrombosis
Hemorrhage
Vascular anomalies

Autoimmune (connective tissue diseases)

Rheumatoid disease
Systemic lupus erythematosis
Rheumatic fever
Scleroderma
Polymyositis-dermatomyositis- Rare
Sjogren's syndrome- Rare
Ankylosing spondylitis- Rare

Toxic

Drugs
Oxygen
Gases and inhaled substances
Radiation

Metabolic

Amyloid
Polychrondritis
Lipoid proteinosis- Rare
Myxedema
Goodpasture's syndrome
Hemosiderosis
Calcification
Ossification

Environmental

Asbestos
Silica
Talc
Berylliosis- Rare

Neoplastic diseases
Benign

Hamartoma
Leiomyoma
Hemangioma

Malignant

Primary pulmonary

Adenocarcinoma
Squamous cell carcinoma
Large cell carcinoma
Neuroendocrine carcinomas

Carcinoid
Atypical carcinoid
Large cell neuroendocrine carcinoma
Small cell carcinoma

Lymphoid malignancies
Sarcomas
Salivary gland-like malignancies- Rare

Pleural
Mesothelioma
Solitary fibrous tumor
Sarcomas- Rare
Metastatic
Note
Although not specifically listed, some of the subtypes of each of the malignancies are rare. For example, papillary adenocarcinoma of the lung and mesothelioma with lymphoid predominance are rarer presentations of these malignancies.

These three features (representativeness, quality, and rarity) describe the case difficulty index. Most pathologists are trained to be able to diagnose accurately approximately 90% of cases, indicating that these cases are not at the very high end of difficulty. Pathologists are not trained very well to handle the other 10% of cases and with the growth of subspecialty pathology (pathologists only examine specimens from specific subspecialties, often based on bodily organ) more pathologists most likely are unable to accurately diagnose this percentage of cases.

In our module embodiments, we grade specimen cases on, for example, a 1-5 case difficulty scale (with one being easy and five being very difficult to diagnose) determined by the pathologist expert and other pre-identified content experts.

We classify pathologists, in this example, into five categories based on their evaluation module score, which corresponds to their ability to handle the three features of difficulty (approximation of percentage of pathologists in parenthesis):

Level 1—novice (10%)

Level 2—intermediate I (20%)

Level 3—intermediate II (60%)

Level 4—expert (9%)

Level 5—master (1%)

For example, an intermediate I pathologist will correctly diagnose most level 1 and level 2 cases and will defer or misdiagnose level 3, 4, and 5 cases.

Criteria Checklists

Criteria checklists are developed with the content expert and reflect the most important criteria that are relevant to the spectrum of cases that are being evaluated. The individual criterion is graded on a Likert scale to measure frequency or strength of that criterion. The combination of criterion for specific cases represents the overall pattern of disease in that case. Thus, the completed checklist of a single case of a common disease in a common presentation (or pattern) and of sufficient quality will look similar to the completed checklist of other cases in the same common presentation of the same disease of sufficient quality. More uncommon presentations of a common disease may have some of the same criteria but other criteria may be more or less prevalent.

These checklists capture the most important criteria that may be used to determine if the trainee subject criteria match the expert pathologist criteria. The comparison of these checklist data and the assessment of matches and mismatches are discussed below under Evaluation Modules.

Different checklists are used for different subspecialties and some subspecialties have different checklists, depending on the diseases being evaluated (e.g., a neoplastic liver checklist separating benign from malignant lesions and a medical liver checklist to separate different inflammatory lesions are two types of checklists for liver training and evaluation).

An example checklist applied for a specific case is shown in Table 7—Example Criteria Checklist for Breast Fine Needle Aspiration Module.

Additional material and study checklist (Table 3) is used when additional material is needed to make a diagnosis. For example, immunohistochemical studies are needed to classify particular tumors.

Corresponding checklist can be prepared for each diagnostic criteria being tested, including: colon cancer, liver cancer, prostate cancer, lung cancer, lymphoma, inflammatory conditions of the liver and colon, and the like.

TABLE 7
Example Criteria Checklist for Breast Fine Needle Aspiration Module

Case 06-C00398
History:
The patient is a 48 year old woman.
Physical examination: 10.0 cm mass in the right breast at 8 o'clock.
Procedure: One pass performed in the One Stop Breast Clinic.

| | | |
|---|---|---|
| Your diagnosis: | | Correct diagnosis: |
| Unsatisfactory | ______ | ______ |
| Benign | ______ | ______ |
| Suspicious | ______ | ______ |
| Malignant | ______ | ______ |
| Specific diagnosis: | ______ | ______ |
| Assessed representativeness level (1-5): | ______ | ______ |
| Assessed rarity level (1-5): | ______ | ______ |
| Assessed quality level (1-5): | ______ | ______ |

Quality
Put an X on the line

| | | |
|---|---|---|
| Low cellularity | ____________ | High cellularity |
| Poor smear (crushing, etc.) | ____________ | Excellent smear |
| Foreign material | ____________ | No foreign material |
| Extremely bloody | ____________ | No blood |
| Obscuring blood, etc. | ____________ | No obscuration |
| Poor staining | ____________ | Excellent staining |

Criteria

| | | |
|---|---|---|
| Benign | | Malignant |
| Monodimensional groups Small or large groups Very cohesive Rounded groups Cells organized Few single cells with cytoplasm Many bipolar cells Nuclei of variable size Variable cellularity Homogeneous chromatin Nuclear membranes regular Nuclear molding absent Absent necrosis Many single myoepithelial cells Frequent apocrine cells | 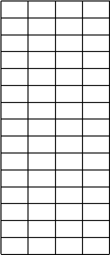 | Three dimensional groups Usually small groups Poorly cohesive Irregular groups Cells disorganized Many single cells with cytoplasm Few bipolar cells in groups Nuclei of same size High cellularity Heterogeneous chromatin Nuclear membranes irregular Nuclear molding present Necrosis Few single myoepithelial cells No apocrine cells |

Atypical features in this case:
_________________________________________________________________________________
_________________________________________________________________________________
_________________________________________________________________________________

### Evaluation Modules

In this example, 25 cases are selected from the case bank for the initial evaluation of a pathologist trainee. This number could change based on need and availability. Pathologist trainees will be asked to diagnose these cases as they would in practice (e.g., definitive diagnosis, non-definitive diagnosis, or refer to a consultant).

The cases will include a spectrum of cases of different diseases of different difficulty based on disease presentation, commonality, and specimen quality. The pathologist trainee provides a diagnosis for each case and scores the case difficulty based on his or her image examination. If the pathologist elects to refer the case to a consultant the pathologist still will give a best diagnosis. For cases with an incorrect diagnosis, the pathologist will be asked to fill out a criteria checklist. Checklist completion will be performed prior to correct diagnoses being provided.

The evaluation module will be graded on a score from 0 to 100% that will correlate with the five levels of expertise. Case diagnoses are scored as correct or incorrect and referred cases are scored as incorrect, although the specific bias resulting in the incorrect diagnosis will be different than if the case diagnosis was scored as incorrect and not referred.

We also will separately score specific disease categories (under this subspecialty) on a similar basis. For example, for the breast module, we will classify disease types into major categories, including ductal proliferative lesions, lobular proliferative lesions, and ductal cancers. A pathologist may have an overall score of intermediate II, a novice level score for lobular proliferative lesions, and a master level score for ductal lesions. We will thus be able to classify each specific disease category as a strength or a weakness that may be targeted with further education.

For incorrect diagnoses, we will determine biases using several methods. First, we will determine if specific biases occurred as a result of the comparison of pathologist and expert checklist. If the pathologist and expert criteria match within our standard assessment, then we classify the error as secondary to a specific list of biases (rather than a knowledge gap, which would reflect another list of biases including an over confidence bias). We perform a correlation analysis to determine the level which individual criterion match between the pathologist and the expert.

Second, the pathologist will answer a number of bias checklist questions that will be provided for cases with incorrect diagnoses. Examples of these bias questions are listed on the last column of the Table 1—Bias Checklist. Our findings indicate that pathologists are more aware of some biases (e.g., anchoring) compared to others (e.g., overconfidence).

### Training Modules

If the pathologist elects to take the training module sets, we use our method of education described herein consisting of immediate focused feedback, building of deliberate practice, focused challenges on individual weakness, skills maintenance standardization, and cognitive bias assessment training. These methods have been utilized in technical skills based-simulation training, but have not been used in cognitive error-based training or specifically in training with cognitive bias.

### Simulation Elements

1) High fidelity. The modules use images from real case slides resulting in the highest fidelity (mimicking real life) as possible. A trainee pathologist views these images as exactly the images (slides) they would examine in day-to-day practice. The same clinical information that is provided to the trainee was provided to the expert. Thus, the pathologist is challenged to think like the expert.

2) Expert-based. The modules are based on the diagnoses of real experts, representing the “expert at work.” The modules are developed for the trainee to understand what the expert thinks when looking at an image. The expert examined every image in real practice and the diagnosis is exactly what the expert thought in that case. Thus, the pathologist will be shown how an expert handles the nuances and challenges in diagnosis. The only way to mimic this training is to have the trainee be present when the expert makes real diagnoses, which would be impossible as expert sees a limited number per day.

3) Immediate feedback. The modules provide immediate feedback on the correct diagnosis. For errors in diagnosis, the modules immediately assess the reason why the trainee made a mistake and this information is provided to the trainee. For diagnostic errors, the trainee completes a criteria and pattern checklist which is matched with the expert's checklist. The trainee also completes a bias checklist. Consequently, the trainee is provided feedback on criteria and patterns and also biases for the causes of the diagnostic error. This modular aspect is unique as current training is based on repeating the diagnostic criteria and patterns to the trainee and does not involve first determining the reasons why the trainee made a mistake. Much training is based on repeating standard criteria and is not based on pattern overlap. There is no formalized training in pathology on bias, memory, and lack of knowledge. No training methods use this form of feedback, which provides unexpectedly good training results.

4) Database dependent. All trainee diagnoses, completed checklist information, assessment levels, etc. are stored in a database that is linked to the modular case database. The trainee database is used to track individual improvement (or regression) and to determine the next set of cases that will be used to challenge the trainee. As more data is entered into the database, we will learn more about the patterns of response, bias, and error that we will use to change feedback, assessment levels, and group performance patterns. We understand that the database allows us to improve feedback and learning opportunities (i.e., a self-learning database).

5) Progressive challenges. As the goal of this training is to focus improvement on trainee weaknesses, the challenges (i.e., modular case images) gradually become more difficult (i.e., in terms of challenging artifacts, unusual presentations, and rarer diseases) and present cases that are associated with specific biases. If the trainee correctly provides the diagnosis for specific difficulty levels of subspecialty case types, then the training does not focus on repeating making a diagnosis on these case examples and focuses on achieving greater mastery. For example, if the trainee correctly diagnoses subspecialty intermediate level I cases then the trainee is challenged with subspecialty level II cases of that subspecialty. In other words, if the trainee correctly diagnoses a case of level 3.2, they will receive additional challenges at a level higher than 3.2.

6) Achievement level and continuous assessment. The training system evaluates each trainee on each set of modular cases and this progress is reported to the trainee for each case subspecialty. Thus, the trainee will always know his or her level of achievement and the weaknesses on which that trainee is working. No other educational program provides this level of training We envision, in one embodiment, an institution will be able to provide CME credits for participating. The program will allow a trainee to continuously learn new skills and be presented with unique challenging cases to achieve a higher level of competence. The trainee may achieve a certificate of their level of training by completing an evaluation module, as described above. The evaluation module is performed over a limited timeframe (e.g., two hours) and the training modules are performed in a schedule that is conducive for the trainee.

7) Skills maintenance and continued practice. The modular training program is designed to test for skills maintenance, or provide challenges to determine if a trainee remembers what he or she has previously learned. If not provided new challenges of a specific skill (e.g., diagnosing a specific artifact such as slide cutting chatter) research data indicate that trainee skill begins to decrease after 5-10 days (i.e., Wickelgren's law of forgetting). Thus, until a trainee attains full mastery of a specific skill set (e.g., recognizing a specific artifact) that trainee will be temporally challenged with cases of demonstrating that specific learning point (e.g., artifact), i.e., challenged on a daily basis, every other day basis, or once every two, three, four, or five day basis. Continued practice using educational cases is a simulation training method that does not exist in current pathology practice.

8) Off-line training. The trainee makes diagnoses as though he or she was in real practice even though that trainee completes the modules in a “virtual” environment. Thus, the trainee is free to learn areas of pathology in which that trainee is inexperienced and to make errors, which cannot result in patient harm. Most pathologists do not have the time to study with an expert and this on-line training method will enable pathologists to learn over time by completing a module a day, for example.

9) Integration into real practice. As the training occurs over a period of time, the trainee may practice pathology at the same time. The learned information may be incorporated into daily practice.

10) Deliberate practice. Deliberate practice is the method by which the training methods become incorporated into self-learning. In the deliberate practice method we have developed, the training method first is incorporated into the practice of responding to an error in diagnosis. Ultimately, this method becomes incorporated into how a pathologist practices. Experts and masters attain their level of expertise and mastery by examining large numbers of cases and learning to know when they do not know. For the trainees in this program, practice is based on learning the reasons that account for case difficulty and moving consciously from a pattern recognition fast process to a slow thinking process of reasoning regarding criteria, patterns, case variability, artifacts, and case rarity. A key component to learning in our modules is the self-recognition of bias. Kahneman and Tversky classify this method as “reference range forecasting” in which the trainee learns to recognize the specific case in comparison to the examples of cases in which bias resulted in an incorrect diagnosis. For example, the trainee will use slow thinking to move beyond the fast pattern thinking to consider specific alternative diagnoses (in rare cases or unusual presentations), artifacts limiting quality, and bias. Deliberate practice has not been incorporated into any training program.

11) High stakes training. High stakes training involves the training in cases in which a mistake could have high risk consequences. In pathology this involves making a false negative or a false positive diagnosis. As specific examples of these cases will be in the expert module case database, we will use these specific cases in the daily training modules. As trainees have different weaknesses, we will target these weaknesses that have high stakes related to their practice.

The training modules consists of at least 10 cases per day, delivered in a similar format as described for the evaluation module. The number and frequency of cases could change but will always consist of at least 2, at least 3, at least 4, at least 5, at least 6, at least 7, at least 8, at least 9, at least 10, at least 11, at least 12, at least 13, at least 14, at least 15 or more per day. The pathologist will report a definitive diagnosis, non-definitive, of refer the case to a consultant. For each case, the pathologist will complete the checklist.

### Example 4

Embodiments of the invention are educational/training method that allows computer-based or hands-on practice and evaluation of clinical, behavior, or cognitive skill performance without exposing patients to the associated risks of clinical interactions.

Components include 1) feedback from an expert; 2) deliberate practice resulting in continued learning; 3) integration with existing practice; 4) outcome measures presented to trainee; 5) fidelity of high approximation to real life practice; 6) skills acquisition and maintenance monitored; 7) mastery learning capabilities; 8) ability to transfer knowledge to daily practice; and 9) high-end stakes training using real-life case sets.

Embodiments herein include 1) learning cytologic criteria for specific diseases; 2) learning multiple criteria, or patterns of disease; and 3) learning heuristics (simple, efficient rules, which explain how people make decisions, come to judgments, and solve problems, typically when facing complex problems or incomplete information—heuristics can work well under certain circumstances, but in certain cases lead to systematic errors or cognitive biases), or mental shortcuts that link disease patterns to specific diseases.

With regard to diagnostic errors, novices require relearning cytologic criteria, intermediate practitioners require relearning patterns of disease and experienced practitioners require relearning heuristics. With regard to cognitive bias: framing is a different conclusion depending on how the information is presented; confirmation is a tendency to interpret information that confirms preconceptions; overconfidence is excessive confidence; neglect of probability is neglect of probability when uncertain and do not harm is judgment based on reducing risk of harm.

Some embodiments of the present invention provide modules of digital image sets used to evaluate and classify performance at a specific level: 1 (novice)-5 (master). Note that modules contain examples of organ specific diseases and that case images are of varying difficulty based on criteria and pattern variability and specimen preparation and other artifacts.

With regard to assessment, practitioners are provided an overall performance score and a performance score for different diagnostic subtypes, reflecting individual strengths and weaknesses (based on diagnostic error). Diagnostic errors are further evaluated using assessments of criteria, patterns, and biases to determine level of expertise.

### Example Assessment

Overall performance score on breast FNA assessment module: 3.2, representing intermediate II level (peer group mean—3.5). Strengths for this individual were: fibroadenoma (4.2), invasive ductal carcinoma (4.3) and benign cyst (4.2). Weaknesses for this individual were: lobular carcinoma (2.3), atypical ductal hyperplasia (2.5) and papillary lesions (2.9).

This practitioner has challenges for some diagnostic patters: cellular lesions with low level of atypia, low cellularity with abundant blood and lesions with single cells. Biases for specific specimen types include recency bias on carcinoma, focus bias on atypical cells and do no harm bias on low cellular specimens.

For this practitioner, a training module is prepared that consist of digital image sets with new challenge cases, tailored to his level of performance (based on the assessment). The case images are of varying difficulty, based on criteria and pattern variability and specimen preparation and other artifacts. Diagnostic errors are evaluated using checklist of criteria, patterns and bias. For criteria errors, feedback is based on relearning diagnostic criteria; for pattern errors, feedback is based on comparison of disease patterns; and for biases, feedback is based on a model of reference range forecasting (how to recognize your bias).

Embodiments of the invention have identified that most diagnostic errors in more experienced practitioners (>80% of our target subjects) occur as a result of: 1) common biases found in examining poor quality specimens; 2) common biases found in examining rare or difficult presentations of common diseases; and 3) common biases found in examining rare diseases. Consequently, embodiments herein, show practitioners how to look at an image and self-teach, including when to use pattern recognition (fast thinking) and when to use more careful, deduction (slow thinking). After each module, the practitioner is reassessed and provided new challenges reflective of previous performance.

Re-assessment for a practitioner is focused on overall and disease subtype performance after completing every eight to twelve training modules, and more typically 10 training modules (for example). Cases for new modules, in this example, are selected based on computerized assessment of prior performance, previous errors, and providing cases of increasing difficulty.

### Example Preparation of Modules

In one example, 2,000 breast cases are accrued and digital images made for each slide. Checklists are used to grade images based on artifact, difficulty and disease rarity. Each case is then added to a database. The graded cases are placed into one of five performance levels: novice, intermediate I, intermediate II, expert or master. Using the bias checklist from Example 3, bias assessments are developed for each case and feedback responses developed. Modules are then developed based on the above information. Modules can be manipulated based on result delivery, peer performance comparison and previous performance levels. This module development can be performed for prostate, bone, colon, lung, pancreatic, lymphoma, etc.

### Results

Testing to date has shown that practitioners at the intermediate I level reach the expert level in approximately four weeks after completing twenty modules. Practitioners at the novice level reach the intermediate II level in two weeks after completing ten training modules. Expert practitioners learn to recognize and control biases after three modules and markedly reduce the frequency of error (up to 80%) on poor quality specimens and rare diseases by lowering propensity of bias.

The description of the present invention has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

What is claimed is:

1. A method of assessing competency of an individual who is a medical student or medical professional, the method comprising the steps of:
(a) providing a first module of one or more graded slides;
(b) testing an individual's knowledge of the slides;
(c) scoring the individual's knowledge; and
(d) comparing the score to a baseline score or a standard score;
wherein a score above the baseline score or standard score indicates the individual's competency.

2. A method of training an individual who is a medical student or medical professional, the method comprising the steps of:
(a) providing a first module of one or more graded slides;
(b) testing an individual's knowledge of the slides;
(c) scoring the individual's knowledge;
(d) comparing the score to a baseline score or a standard score; and
(e) providing feedback regarding the individual's knowledge of the slides.

3. The method of claim 2, further comprising the step of providing a second module of one or more graded slides, the second module being chosen based on the comparison of the individual's score to the baseline score or standard score.

4. A system for assessing competency of an individual who is a medical student or medical professional, the system comprising:
(a) a first module of one or more graded slides;
(b) a baseline score or a standard score; and
(c) a verbal or electronic means of comparing the individual's score to the baseline or standard score.

5. A system for training an individual who is a medical student or medical professional, the system comprising:
(a) a first module of one or more graded slides;
(b) a baseline score or a standard score; and
(e) a feedback mechanism.

6. The method of claim 1 further comprising the individual completing a criteria checklist that corresponds to the subject matter of the first module.

7. The method of claim 6 further comprising the individual answering bias questions for each incorrect diagnosis in the first module.

8. The method of claim 7 wherein the bias questions are listed in Table 1.

9. A simulation and training system for training an individual comprising:
at least 25 individual cases in a pre-identified disease wherein the cases fall into one or three categories: common disease with unusual presentation, common disease with quality artifacts that result in more challenging interpretation, and rarer disease;
a criteria checklist that contains a list of criterion specific for the at least 25 cases in the pre-identified disease, wherein the individual completes the checklist for each of the at least 25 individual cases and wherein based on the individual responses to the criteria checklist a training module is provided to the individual having at least 10 cases tailored to the individual's strengths and weaknesses at responding to the criteria checklist.

10. The simulation and training system of claim 9 wherein the criteria checklist provides a score for competency in the predetermined disease and a score in one or more subspecialty of the predetermined disease.

11. The simulation and training system of claim 10 wherein the individual is further required to complete a bias checklist to compare to the individual's responses on the criteria checklist.

12. The simulation and training system of claim 11 wherein the bias checklist includes a number of questions that when combined with the results of the criteria checklist further tailors the content of the at least 10 cases in the individual's training module to challenge the individual's weakness, skill maintenance and cognitive bias.

13. The simulation and training system of claim 9 wherein the at least 10 cases of the training module are digital cases.

14. The simulation and training system of claim 12 further comprising a second training module of at least 10 cases tailored to challenge and focus the individual to become more proficient and remove bias from the individual's diagnosis.

15. The simulation and training system of claim 14 further comprising at least three training modules of at least 10 cases, each subsequent module tailored to further challenge and focus the individual to become more proficient and remove bias from the individual's diagnosis.

16. The simulation and training system of claim 12 wherein the individual is further requested to determine whether any of the at least 25 cases require any additional ancillary stains or materials to make a correct diagnosis, wherein the individual's responses are used in further tailoring the content of the at least 10 cases in the training module.
